(19) United States
(12) Patent Application Publication
(10) Pub. No.: US 2016/0014117 A1
(43) Pub. Date: Jan. 14, 2016

(54) Authentication method using security token, and system and apparatus for same

(71) Applicant: SK PLANET CO., LTD., Seongnam-si (KR)

(72) Inventors: Kyungwan KO, Seoul (KR); Bongsu UM, Seoul (KR)

(21) Appl. No.: 14/863,968

(22) Filed: Sep. 24, 2015

Related U.S. Application Data
(63) Continuation of application No. PCT/KR2013/012157, filed on Dec. 26, 2013.

(30) Foreign Application Priority Data
Jun. 5, 2013 (KR) 10-2013-0064495
Jun. 7, 2013 (KR) 10-2013-0065364

(51) Int. Cl. H04L 29/06; H04L 29/08

(52) U.S. Cl. CPC H04L 63/0838; H04L 67/306

(57) ABSTRACT

The present invention relates to an authentication method using a security token, and a system and apparatus for implementing the method. This invention enhances security against outside hacking (cookie hijacking) by performing verification using a single-use security token at the time of access to a logic processing apparatus and by performing authentication through the verification of the security token, to which bidirectional encryption is applied, at the time of re-login for the use of a service on a web. Additionally, since an authentication value constituting the security token can be changed by applying various calculation schemes, the safety of an authentication procedure is ensured. Furthermore, the use of a single-use security token instead of security or authentication information exposed in an authentication process based on a cookie scheme not only reduces a token length, data loss, and data usage, but also improves a data transmission or transfer rate.

### CROSS-REFERENCE TO RELATED APPLICATIONS

The present application is a continuation of International Patent Application No. PCT/KR2013/012157, filed Dec. 26, 2013, which claims priority to Korean Patent Application No. 10-2013-0064495, filed on Jun. 5, 2013, and Korean Patent Application No. 10-2013-0065364, filed on Jun. 7, 2013, all of which are hereby incorporated by reference in their entirely.

### BACKGROUND OF THE INVENTION

1. Field of the Invention

The present invention relates to an authentication method using a security token, and a system and apparatus for the same. More particularly, the present invention relates to a method for performing verification for authentication by using a single-use security token at the time of access to a logic processing apparatus, and for performing authentication through the verification of the security token, to which bidirectional encryption is applied, at the time of re-login for the use of a service on a web, and a system and apparatus for this method.

2. Description of the Related Art

With the growth of mobile communication networks and related technologies, a great variety of services based on wired/wireless communication networks are now being offered. However, since user identification (ID) systems are distributed and managed separately according to respective services, this causes several problems such as customer's inconvenience, difficulties of information security, difficulties with the observance of related regulations, the hindrance to the introduction of a new service, the obstruction to an interconnection between services, and the like. Thus, there arises a need to integrate user IDs of various services, and an integrated authentication system (tentatively named) for managing a single integrated ID is now being developed.

In the construction of this integrated authentication system, the integration of user IDs should consider flexibility capable of accepting various membership policies (qualification for membership, the range of membership, a verification method of a member, etc.) of services, stability in management, sustainability of services, scalability, and the like.

Particularly, in order to integrate authentication in many web services or applications and thereby to allow the use of such services or applications by only one authentication, an integrated authentication server is separately constructed to perform the authentication of different services or applications, or authentication information of a certain application or service is delivered to other service or authentication server through SSO (Single Sign-On) technique so that a user may not need to log in again. Related technologies may be classified into types of using cookie, session, authentication token, ticket, and the like, depending on delivery methods of authentication information. Also, depending on targets to be integrated, such technologies may be classified into a single authentication between web services, a single authentication between applications, a single authentication between a network access and a service, and the like.

However, authentication information used in an authentication process on a web (HTTP environment) may be copied or monitored and then abused by hackers. In this case, user's personal information may be leaked to the outside.

### BRIEF SUMMARY OF THE INVENTION

In order to solve the above problems, the present invention is to provide a method, system and apparatus for authentication using a security token, being capable of maintaining security against outside hacking (cookie hijacking) by performing verification using a single-use security token at the time of access to a logic processing apparatus.

Also, the present invention is to provide a method, system and apparatus for authentication using a security token, being capable of maintaining security against outside hacking by performing authentication through the verification of the security token, to which bidirectional encryption is applied, at the time of re-login for the use of a service.

An authentication apparatus according to an embodiment of the present invention for accomplishing the above purpose comprises a service communication unit connected with at least one terminal and a logic processing apparatus and configured to transmit or receive data for performing authentication using an authentication security token and data for maintaining login using a login maintenance security token; an integrated ID management unit configured to perform login authentication in response to a request of the terminal; a security token creation unit configured to issue the authentication security token in case of success in login, and to transmit a message containing the authentication security token to the terminal; and a security token verification unit configured to perform verification of the authentication security token when the verification of the authentication security token is requested from the logic processing apparatus, and to offer membership information to the logic processing apparatus by applying a membership information inquiry key value when the authentication security token is verified.

Additionally, in the authentication apparatus according to this invention, the authentication security token is a single-use security token which is issued through the security token creation unit and is set to be valid only at a first verification request of the logic processing apparatus.

Additionally, in the authentication apparatus according to this invention, the login maintenance security token is formed of a first authentication value reissued whenever ID is authenticated, and a second authentication value including information about a user profile for performing login authentication with specific ID.

Additionally, in the authentication apparatus according to this invention, the security token creation unit is further configured to issue and transmit the login maintenance security token to the terminal when the login succeeds, and to change and transmit an authentication value of the login maintenance security token to the terminal in response to a request for re-login authentication.

Additionally, in the authentication apparatus according to this invention, the security token verification unit is further configured to perform verification of the login maintenance security token when the verification of the login maintenance security token for re-login authentication of the logic processing apparatus is requested from the terminal.

Additionally, in the authentication apparatus according to this invention, the security token verification unit is further configured to check whether the authentication security token received from the logic processing apparatus is about a first verification request, and in case of the authentication security token about the first verification request, to create and offer a membership information inquiry key value associated with the terminal to the logic processing apparatus.

A terminal according to an embodiment of this invention comprises a communication unit configured to communicate with an authentication apparatus and a logic processing apparatus for providing a service, and to transmit or receive data for performing authentication using an authentication security token and data for performing login maintenance using a login maintenance security token; and a control unit configured to perform login authentication by accessing the logic processing apparatus, to receive a message containing the authentication security token from the authentication apparatus in case of success in login, to transmit the authentication security token identified by analyzing the received message to the logic processing apparatus, and to control use of a plurality of services provided from the logic processing apparatus depending on a verification result of the authentication security token.

Additionally, in the terminal according to this invention, further comprised is a memory unit configured to store the authentication security token identified by analyzing the message received from the authentication apparatus, and the login maintenance security token received for re-login from the authentication apparatus or identified by analyzing the message received from the authentication apparatus.

Additionally, in the terminal according to this invention, the control unit is further configured to check whether there is the login maintenance security token for re-login authentication, to request the authentication apparatus to verify the login maintenance security token if there is the login maintenance security token, to perform re-login authentication based on the login maintenance security token when the login maintenance security token is verified, and to receive the login maintenance security token having an authentication value changed according to re-login authentication from the authentication apparatus.

An authentication system using a security token according to an embodiment of this invention comprises a terminal configured to perform login authentication by accessing a logic processing apparatus, to receive a message containing an authentication security token from an authentication apparatus in case of success in login, to transmit the authentication security token identified by analyzing the received message to the logic processing apparatus, and to use a plurality of services provided from the logic processing apparatus depending on a verification result of the authentication security token; and the authentication apparatus configured to perform login authentication for access to the logic processing apparatus in response to a request of the terminal, to issue the authentication security token in case of success in login, to transmit the message containing the authentication security token to the terminal, to perform verification of the authentication security token when the verification of the authentication security token is requested from the logic processing apparatus, and to offer membership information to the logic processing apparatus by applying a membership information inquiry key value when the authentication security token is verified.

An authentication method using a security token according to an embodiment of this invention comprises steps of, at a terminal, checking whether there is a login maintenance security token for re-login authentication; at the terminal, requesting an authentication apparatus to verify the login maintenance security token if there is the login maintenance security token; at the terminal, performing re-login authentication based on the login maintenance security token when the login maintenance security token is verified; and at the terminal, receiving the login maintenance security token having an authentication value changed according to the re-login authentication from the authentication apparatus.

Additionally, in the authentication method according to this invention, further comprised are steps of, at the terminal, before the checking step, performing login authentication for providing a service; at the terminal, receiving a login maintenance security token from the authentication apparatus in case of success in login; and at the terminal, storing the received login maintenance security token.

Additionally, in the authentication method according to this invention, the checking step includes step of, at the terminal, outputting an input screen for performing login authentication by using ID and password if there is no login maintenance security token.

Additionally, in the authentication method according to this invention, further comprised step of, at the terminal, after the receiving step, storing the login maintenance security token having a changed specific authentication value instead of an existing login maintenance security token.

An authentication method using a security token according to an embodiment of this invention comprises steps of, at an authentication apparatus, performing login authentication for access to a logic processing apparatus for providing a service in response to a request of at least one terminal; at the authentication apparatus, issuing a login maintenance security token in case of success in login; at the authentication apparatus, performing verification of the login maintenance security token when the verification of the login maintenance security token for re-login authentication is requested from the terminal; at the authentication apparatus, changing an authentication value of the login maintenance security token when the login maintenance security token is verified; and at the authentication apparatus, transmitting the login maintenance security token having the changed authentication value to the terminal.

Additionally, in the authentication method according to this invention, the step of performing the login authentication includes steps of, at the authentication apparatus, offering an input screen for ID and password; and at the authentication apparatus, receiving ID and password from the terminal and identifying the received ID and password.

Additionally, in the authentication method according to this invention, the step of performing the verification of the login maintenance security token includes, at the authentication apparatus, checking whether the login maintenance security token received from a specific terminal is identical with one of login maintenance security tokens issued previously for respective terminals.

Additionally, in the authentication method according to this invention, further comprised is step of, at the authentication apparatus, after the step of performing the verification of the login maintenance security token includes, transmitting a warning message to the terminal in case of failure in verification of the login maintenance security token.

Additionally, in the authentication method according to this invention, the changing step includes, at the authentication apparatus, changing a first authentication value, from among first and second authentication values constituting the login maintenance security token, by applying at least one calculation scheme.

An authentication method using a security token according to an embodiment of this invention comprises steps of, at a terminal, performing login authentication by accessing a specific logic processing apparatus; at the terminal, receiving a message containing an authentication security token from an authentication apparatus in case of success in login; at the terminal, identifying the authentication security token by analyzing the received message; at the terminal, transmitting the authentication security token to the logic processing apparatus; and at the terminal, using a plurality of services provided from the logic processing apparatus depending on a verification result of the authentication security token.

Additionally, in the authentication method according to this invention, the identifying step includes, at the terminal, checking information contained in the message received from the authentication apparatus, the information corresponding to one or more of code information of a service providing site, URL information for transmission of the authentication security token, code information for indicating a domestic or foreign site, and information about the authentication security token.

Additionally, in the authentication method according to this invention, further comprised is step of, at the terminal, storing the authentication security token contained in the message after the identifying step.

An authentication method using a security token according to an embodiment of this invention comprises steps of, at an authentication apparatus, performing login authentication for access to a specific logic processing apparatus in response to a request of at least one terminal; at the authentication apparatus, issuing an authentication security token in case of success in login; at the authentication apparatus, transmitting a message containing the authentication security token to the terminal; at the authentication apparatus, performing verification of the authentication security token when the verification of the authentication security token is requested from the logic processing apparatus; and at the authentication apparatus, offering membership information to the logic processing apparatus by applying a membership information inquiry key value when the authentication security token is verified.

Additionally, in the authentication method according to this invention, the step of performing the login authentication includes steps of, at the authentication apparatus, offering an input screen for ID and password in response to a request for access to the logic processing apparatus; and at the authentication apparatus, receiving ID and password from the terminal and identifying the received ID and password.

Additionally, in the authentication method according to this invention, the step of performing the verification of the authentication security token includes steps of, at the authentication apparatus, checking whether the authentication security token received from the logic processing apparatus is about a first verification request; and at the authentication apparatus, in case of the authentication security token about the first verification request, creating a membership information inquiry key value associated with the terminal.

Additionally, in the authentication method according to this invention, the step of performing the verification of the authentication security token includes step of, at the authentication apparatus, if the authentication security token is not about a first verification request, sending a warning message to the logic processing apparatus.

Additionally, in the authentication method according to this invention, the offering step includes steps of, at the authentication apparatus, receiving an inquiry request for membership information associated with the membership inquiry key value from the logic processing apparatus; at the authentication apparatus, inquiring into the membership information in response to the request; and at the authentication apparatus, transmitting an inquiry result to the logic processing apparatus.

According to the present invention, by performing authentication through the verification of the security token, to which bidirectional encryption is applied, at the time of re-login for the use of a service, it is possible to improve security against outside hacking (cookie hijacking).

Additionally, since an authentication value constituting a security token can be changed by applying various calculation schemes, the safety of an authentication procedure is ensured.

Furthermore, by using a single-use security token instead of security or authentication information exposed in an authentication process based on a cookie scheme, a token length, data loss, and data usage can be reduced, and also a data transmission or transfer rate can be improved.

Moreover, by performing authentication using a single-use security token, security against outside hacking can be enhanced.

### BRIEF DESCRIPTION OF THE DRAWINGS

FIG. 1 is a diagram illustrating an authentication system using a security token in accordance with an embodiment of the present invention.

FIG. 2 is a block diagram illustrating the configuration of a terminal in accordance with the present invention.

FIG. 3 is a block diagram illustrating the configuration of an authentication apparatus in accordance with the present invention.

FIG. 4 is a data flow diagram illustrating an authentication process using a security token in accordance with an embodiment of the present invention.

FIG. 5 is a flow diagram illustrating an operating method of a terminal in accordance with an embodiment of the present invention.

FIGS. 6 and 7 are flow diagrams illustrating an operating method of an authentication apparatus in accordance with an embodiment of the present invention.

FIG. 8 is a data flow diagram illustrating an authentication process using a security token in case of maintaining login in accordance with another embodiment of the present invention.

FIG. 9 is a flow diagram illustrating an operating method of a terminal in accordance with another embodiment of the present invention.

FIG. 10 is a flow diagram illustrating an operating method of an authentication apparatus in accordance with another embodiment of the present invention.

### DETAILED DESCRIPTION OF THE PREFERRED EMBODIMENTS

Hereinafter, preferred embodiments of the present invention will be described with reference to the accompanying drawings. However, well known functions or structures may not be described or illustrated in detail to avoid obscuring the subject matter of the present invention. Through the drawings, the same or similar reference numerals denote corresponding features consistently.

The terms and words used in the following description and claims are not limited to the bibliographical meanings, but, are merely used by the inventor to enable a clear and consistent understanding of the present invention. Accordingly, it should be apparent to those skilled in the art that the following description of various embodiments of the present invention is provided for illustration purpose only and not for the purpose of limiting the present invention as defined by the appended claims and their equivalents.

Hereinafter, a terminal according to embodiments of this invention will be described as a mobile communication device capable of performing authentication by using a single-use security token in a state of connection with a communication network, or performing authentication by using a security token at the time of re-login for the use of a service. The mobile communication device is, however, exemplary only and a great variety of devices such as all kinds of information communication devices, multimedia devices, wired/wireless devices, stationary devices, and internet protocol (IP) devices may be used as the terminal for this invention. Particularly, this invention may be applied to an operating system (OS) incapable of data check between applications and including mobile OS such as iOS, Android, Symbian, Bada, or the like, adapted for a mobile environment. Also, mobile devices having various mobile communication specifications such as a cellular phone, a portable multimedia player (PMP), a mobile internet device (MID), a smart phone, a desktop, a table PC, a notebook, a netbook, a server, or any other information communication device may be favorably utilized.

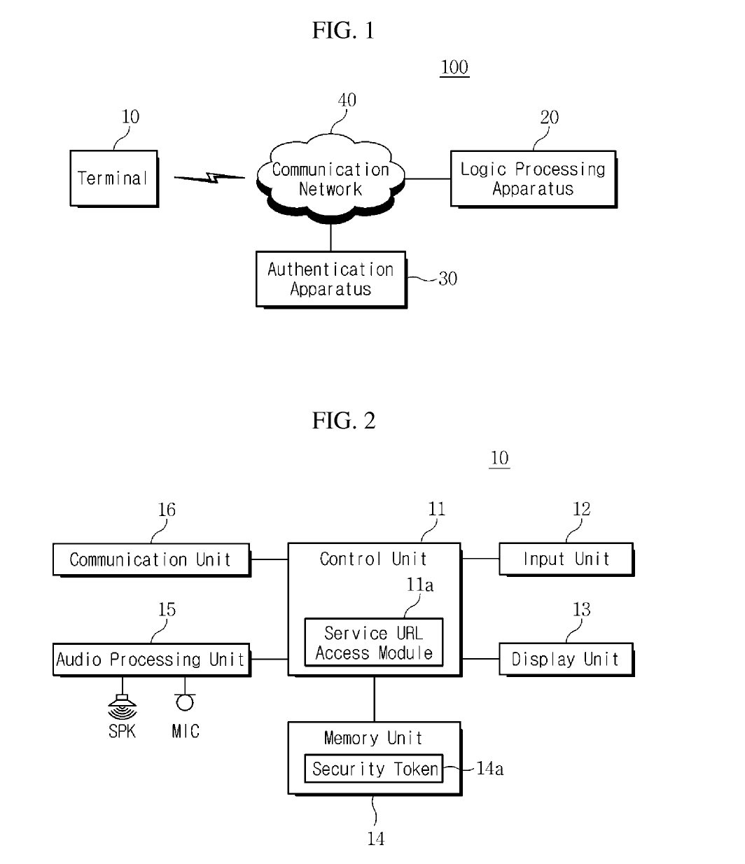

FIG. 1 is a diagram illustrating an authentication system using a security token in accordance with an embodiment of the present invention.

Referring to FIG. 1, the authentication system 100 using the security token in accordance with this invention is configured to include a terminal 10, a logic processing apparatus 20, an authentication apparatus 30, and a communication network 40.

The communication network 40 performs the transmission of data and the exchange of information among the terminal 10, the logic processing apparatus 20, and the authentication apparatus 30. Particularly, the communication network 40 may use various types of networks based on, for example, a wireless communication scheme such as WLAN (Wireless LAN), Wi-Fi, Wibro, Wimax, or HSDPA (High Speed Downlink Packet Access), and a wired communication scheme such as Ethernet, xDSL (ADSL, VDSL), HFC (Hybrid Fiber Coax), FTTC (Fiber To The Curb), or FTTH (Fiber To The Home). Meanwhile, the communication network 40 may be limited to the above schemes, and any other well-known or possible communication scheme may be employed.

The terminal 10 is connected with the logic processing apparatus 20 and the authentication apparatus 30 through the communication network 40 and then transmits or receives all data for performing authentication using an authentication security token. Particularly, the terminal 10 according to an embodiment of this invention accesses the logic processing apparatus 20 by using a service URL and then performs login authentication. In case of success in login, the terminal 10 receives a message including the authentication security token from the authentication apparatus 30 and transmits the authentication security token identified by analyzing the received message to the logic processing apparatus 20. Then, depending on a verification result of the authentication security token, the terminal 10 uses a plurality of services provided from the logic processing apparatus 20.

Additionally, the terminal 10 according to another embodiment of this invention is connected with the logic processing apparatus 20 and the authentication apparatus 30 through the communication network 40 and then transmits or receives all data for performing authentication using a login maintenance security token. Particularly, the terminal 10 according to an embodiment of this invention accesses the authentication apparatus 30 so as to use a service and then performs login authentication.

When re-login for the use of a service is requested, the terminal 10 checks whether there is a login maintenance security token for the authentication of re-login. If there is the login maintenance security token, the terminal 10 requests the authentication apparatus 30 to verify the login maintenance security token. After the login maintenance security token is verified, the terminal 10 performs re-login authentication based on the login maintenance security token. In this case, the terminal 10 receives, from the authentication apparatus 30, the login maintenance security token having an authentication value changed according to re-login authentication. Here, the login maintenance security token is formed of the first authentication value reissued whenever ID is authenticated, and the second authentication value including information about a user profile for performing login authentication with specific ID.

The authentication apparatus 30 is connected with the terminal 10 and the logic processing apparatus 20 through the communication network 40 and then transmits or receives all data for performing authentication using an authentication security token. Particularly, the authentication apparatus 30 according to an embodiment of this invention performs login authentication for access to the logic processing apparatus 20 in response to a request of the terminal 10. In case of success in login, the authentication apparatus 30 issues an authentication security token and then transmits a message including the authentication security token to the terminal 10.

If the verification of the authentication security token is requested from the logic processing apparatus 20, the authentication apparatus 30 performs the verification of the authentication security token. Then if the authentication security token is verified, the authentication apparatus 30 applies a membership information inquiry key value and transmits membership information to the logic processing apparatus 20.

Additionally, the authentication apparatus 30 according to another embodiment of this invention is connected with the terminal 10 and the logic processing apparatus 20 through the communication network 40 and then transmits or receives all data for performing authentication using a login maintenance security token. Particularly, the authentication apparatus 30 according to an embodiment of this invention performs login authentication for access to the logic processing apparatus 20 in response to a request of the terminal 10. In case of success in login, the authentication apparatus 30 issues a login maintenance security token and then transmits the login maintenance security token to the terminal 10.

If the verification of the login maintenance security token for re-login authentication is requested from the terminal 10, the authentication apparatus 30 performs the verification of the login maintenance security token. Then if the login maintenance security token is verified, the authentication apparatus 30 changes an authentication value of the login maintenance security token. In this case, by applying various calculation schemes, the authentication apparatus 30 may change the first authentication value from among the first and second authentication values constituting the login maintenance security token. Thereafter, the authentication apparatus 30 transmits the login maintenance security token having the changed authentication value to the terminal 10.

The logic processing apparatus 20 is connected with the terminal 10 and the authentication apparatus 30 through the communication network 40 and then transmits or receives all data for performing authentication using the authentication security token. Particularly, the logic processing apparatus 20 according to an embodiment of this invention requests the authentication apparatus 30 to verify the authentication security token in response to a request of the terminal 10. Then, depending on a verification result from the authentication apparatus 30, the logic processing apparatus 20 inquires into membership information associated with the terminal 10.

Additionally, the logic processing apparatus 20 according to another embodiment of this invention is connected with the terminal 10 and the authentication apparatus 30 through the communication network 40 and then transmits or receives all data for performing authentication using the login maintenance security token. Particularly, the logic processing apparatus 20 according to an embodiment of this invention provides a service to the terminal 10 according to a verification result.

As discussed above, by performing authentication through the verification of the security token, to which bidirectional encryption is applied, at the time of re-login for the use of a service, this invention can improve security against outside hacking (cookie hijacking) Also, by performing authentication using a single-use security token, security against outside hacking can be enhanced. Additionally, since an authentication value constituting the security token can be changed by applying various calculation schemes, the safety of an authentication procedure is ensured. Further, by using a single-use security token instead of security or authentication information exposed in an authentication process based on a cookie scheme, a token length, data loss, and data usage can be reduced, and also a data transmission or transfer rate can be improved.

According to this invention, the SSO authentication scheme may be applied as authentication measures for accessing the logic processing apparatus 20 and then using a service. There are three types of the SSO (Single Sign-On) authentication scheme, i.e., a basic authentication scheme, an ID federation authentication scheme, and an assertion authentication scheme. First, the basic authentication scheme is widely used in case of constructing a new system or integrating user information. Therefore, integrated authentication information and an integrated login page are contained in a central authentication server. Second, the ID federation authentication scheme is used in case of continuing to use existing user information when there are authentication information management servers for respective individual service providers. Therefore, a central authentication server has no integrated authentication information, but has authentication information for indicating login or not so as to perform a central management of login. Third, the assertion authentication scheme is suitable for case of using both existing authentication information and integrated authentication information. A service provider has a login page and performs forced login processing to a central authentication server after login processing. In this case, since two types of authentication information coexist, a synchronization process for authentication information is needed.

Meanwhile, a processor installed in the terminal 10 or the authentication apparatus 30 according to this invention may process a program command for implementing a method according to this invention. This processor may be a single-threaded processor in an embodiment, and be a multi-threaded processor in another embodiment. Furthermore, this processor can also process a command stored in a memory or storage.

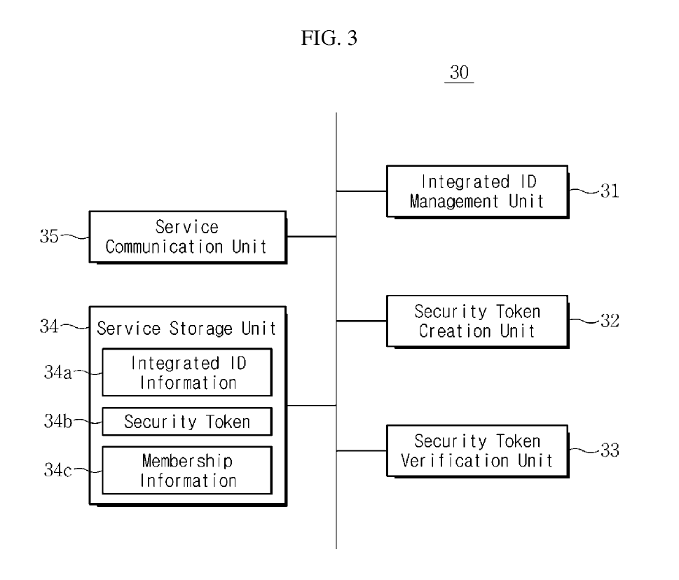

FIG. 2 is a block diagram illustrating the configuration of a terminal in accordance with the present invention.

Referring to FIG. 2, the terminal 10 according to the present invention includes a control unit 11, an input unit 12, a display unit 13, a memory unit 14, and a communication unit 15. Here, the control unit 11 includes a service URL access module 11a, and the memory unit 14 includes a security token 14a.

The input unit 12 receives various types of information based on numbers, letters, or the like, and delivers an input signal for setting or controlling various functions of the terminal 10 to the control unit 11. Additionally, the input unit 12 may be configured to include at least one of a keypad and a touchpad each of which creates an input signal in response to a user's touch or manipulation. Further, the input unit 12 may be realized in the form of a single touch panel (or a touch screen) together with the display unit 13 and thus simultaneously perform input and display functions. Also, the input unit 12 may use various input devices such as a keyboard, a keypad, a mouse, a joystick, and any other input manner. Particularly, the input unit 12 according to an embodiment of this invention receives an input of ID and password for access to the logic processing apparatus 20 and delivers it to the control unit 11.

The display unit 13 displays thereon information about operating states and results while a function of the terminal 10 is performed. Additionally, the display unit 13 may display a menu of the terminal 10 and user data entered by a user. Here, the display unit 13 may be formed of LCD (Liquid Crystal Display), TFT-LCD (Thin Film Transistor LCD), LED (Light Emitting Diode), OLED (Organic Light Emitted Diode), AMOLED (Active Matrix OLED), a retina display, a flexible display, a three dimensional display, or the like. In case of being formed as a touch screen, the display unit 13 may perform a part or all of functions of the input unit 12. Particularly, the display unit 13 according to an embodiment of this invention outputs a screen for entering an input of ID and password for access to the logic processing apparatus 20.

The memory unit 14, which is a device for storing data therein, includes a main memory and an auxiliary memory, and stores a program required for the operation of the terminal 10. The memory unit 14 may include a program region and a data region. When a user's request for activating a certain function is received, the terminal 10 offers the requested function under the control of the control unit 11 by invoking a corresponding program from the memory unit 14. Particularly, the memory unit 14 according to this invention stores therein an operating system (OS) for booting the terminal 10, a program for identifying a security token offered from the authentication apparatus 30, a program for requesting re-login for the use of a service, a program for accessing the logic processing apparatus 20, a program for parsing a message containing a security token offered from the authentication apparatus 30, and the like. Additionally, the memory unit 14 stores therein the security token 14a offered from the authentication apparatus 30. Here, the security token 14a is formed of the first authentication value (a random value) reissued whenever ID is authenticated, and the second authentication value (a unique value) including information about a user profile for performing login authentication with specific ID. For example, if a security token “0101abc” formed of the second authentication value “0101” and the first authentication value “abc”, the first authentication value may be changed every re-login for the use of a service. Namely, a login maintenance security token is used as “0101abc” at the first login, is used as “0101efg” at the second login, and is changed to “0101hij” at the third login.

The communication unit 15 performs a function to transmit or receive data to or from the logic processing apparatus 20 and the authentication apparatus 30 through the communication network 40. Here, the communication unit 15 includes a radio frequency (RF) transmitter that up-converts the frequency of outgoing signals and amplifies such signals, an RF receiver that amplifies with low-noise incoming signals and down-converts the frequency of such signals, and the like. The communication unit 15 may include at least one of a wireless communication module (not shown) and a wired communication module (not shown). The wireless communication module is configured to transmit or receive data, based on wireless communication schemes, and may transmit or receive data to or from the authentication apparatus 30 by using one of a wireless network communication module, a WLAN communication module, and a WPAN communication module when the terminal 10 uses a wireless communication. The wired communication module is configured to transmit or receive data in a wired manner, and may transmit or receive data to or from the authentication apparatus 30 by accessing the communication network 40 in a wired manner. Namely, the terminal 10 can access the communication network 40 by using such a wireless or wired communication module and then transmit or receive data to or from the authentication apparatus 30 through the communication network 40. Particularly, the communication unit 15 according to an embodiment of this invention communicates with the logic processing apparatus 20 and the authentication apparatus 30, and transmits or receives data for performing authentication using the authentication security token or the login maintenance security token.

The control unit 11 may be a processing unit configured to drive the OS and respective elements. Particularly, the control unit 11 according to this invention accesses the logic processing apparatus 20 by using a service URL, and performs login authentication. In case of success in login, the control unit 11 receives a message containing the authentication security token from the authentication apparatus 30.

The control unit 11 identifies the authentication security token by analyzing the received message. At this time, the control unit 11 checks information contained in the message received from the authentication apparatus 30, such as code information of a service providing site, URL information for transmission of the authentication security token, code information for indicating a domestic or foreign site, or information about the authentication security token. Here, the authentication security token is issued through the authentication apparatus 30, and is a single-use security token which is set to be valid only at the first verification request of the logic processing apparatus 20. Then the control unit 11 stores and manages the authentication security token contained in the message.

The control unit 11 transmits the authentication security token to the logic processing apparatus 20. Also, depending on verification results of the authentication security token, the control unit 11 uses a plurality of services provided from the logic processing apparatus 20.

Additionally, the control unit 11 according to another embodiment of this invention accesses the logic processing apparatus 20 providing services and performs login authentication. In case of success in login, the control unit 11 receives the login maintenance security token from the authentication apparatus 30. Here, the login maintenance security token is formed of the first authentication value (a random value) reissued whenever ID is authenticated, and the second authentication value (a unique value) including information about a user profile for performing login authentication with specific ID.

The control unit 11 checks whether there is the login maintenance security token for re-login authentication. If there is the login maintenance security token, the control unit 11 requests the authentication apparatus 30 to verify the login maintenance security token. On the contrary, if there is no login maintenance security token, the control unit 11 outputs an input screen for performing login authentication using ID and password.

After the verification of the login maintenance security token, the control unit 11 performs re-login authentication based on the login maintenance security token. Also, the control unit 11 receives, from the authentication apparatus 30, the login maintenance security token having an authentication value changed according to re-login authentication. Thereafter, the control unit 11 stores the login maintenance security token having a changed specific authentication value instead of the existing security token.

In order to effectively perform a function of the terminal 10 as discussed above, the control unit 11 includes the service URL access module 11a. Particularly, the service URL access module 11a supports a function to perform authentication using the security token offered through the logic processing apparatus 20 and the authentication apparatus 30.

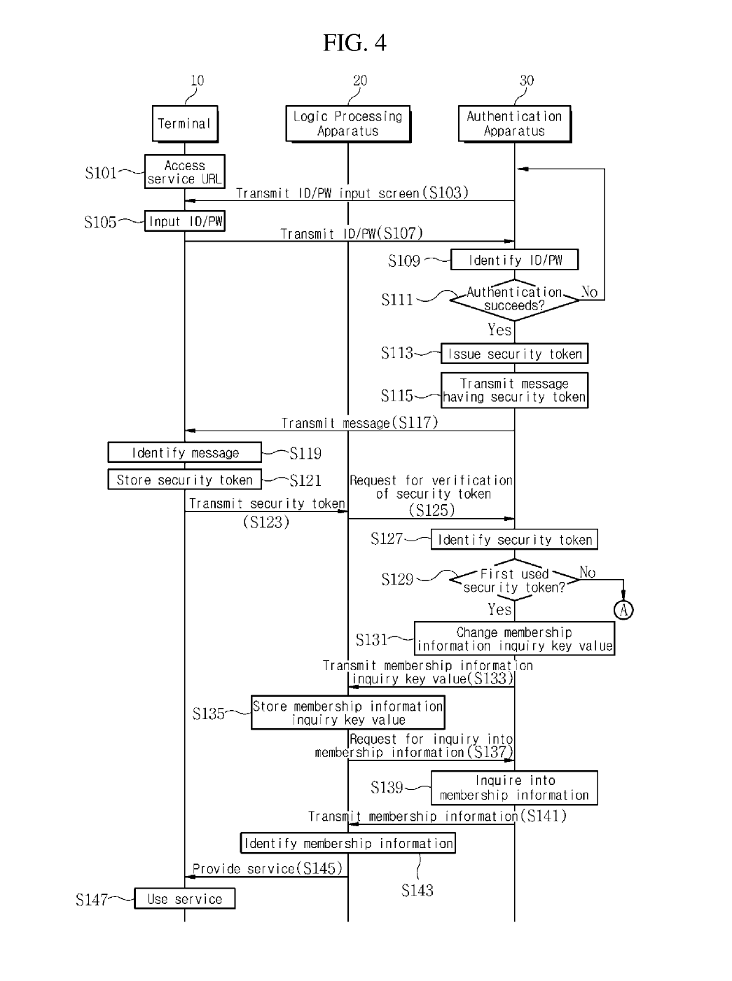

FIG. 3 is a block diagram illustrating the configuration of an authentication apparatus in accordance with the present invention.

Referring to FIG. 3, the authentication apparatus 30 is configured to include an integrated ID management unit 31, a security token creation unit 32, a security token verification unit 33, a service storage unit 34, and a service communication unit 35. Here, the service storage unit 34 includes integrated ID information 34a, a security token 34b, and membership information 34c.

The service communication unit 35 is connected with the terminal 10 and the logic processing apparatus 20, and transmits or receives all data for performing authentication using the security token.

The service storage unit 34 stores therein programs and data for performing a function of the authentication apparatus 30. Particularly, the service storage unit 34 stores the integrated ID information 34a to be used for performing login by means of ID and password of the terminal 10, the security token 34b to be used for performing authentication of the terminal 10, and the membership information 34c about a user of the terminal 10.

The integrated ID management unit 31 performs login authentication for access to the logic processing apparatus 20 in response to a request of the terminal 10. Here, the integrated ID management unit 31 offers an input screen for ID and password in response to a request for access to the logic processing apparatus 20, and identifies the ID and password received from the terminal 10.

If the ID and password of the terminal 10 are authenticated and thereby the login succeeds, the security token creation unit 32 issues the authentication security token and transmits a message containing the authentication security token to the terminal 10. Here, the authentication security token is a single-use security token which is set to be valid only at the first verification request of the logic processing apparatus 20.

If the ID and password of the terminal 10 are authenticated and thereby the login succeeds, the security token creation unit 32 issues the login maintenance security token and transmits the login maintenance security token to the terminal 10. Here, the login maintenance security token is formed of the first authentication value (a random value) reissued whenever ID is authenticated, and the second authentication value (a unique value) including information about a user profile for performing login authentication with specific ID.

If re-login authentication is completed in response to a re-login authentication request of the terminal 10 to use a service, the security token creation unit 32 changes an authentication value of the login maintenance security token and transmits the login maintenance security token to the terminal 10. Here, the security token creation unit 32 may change the first authentication value from among the first and second authentication values constituting the login maintenance security token by applying various calculation schemes such as +, −, shift, or the like.

The security token verification unit 33 checks whether the authentication security token received from the logic processing apparatus 20 is about the first verification request. In case of the authentication security token about the first verification request, the security token verification unit 33 creates a membership information inquiry key value associated with the terminal 10. On the contrary, if the authentication security token is not about the first verification request, the security token verification unit 33 transmits a warning message to the logic processing apparatus 20.

In case the authentication security token is verified, the security token verification unit 33 applies the membership information inquiry key value and offers membership information to the logic processing apparatus 20. Namely, the security token verification unit 33 receives an inquiry request for membership information associated with a membership inquiry key value from the logic processing apparatus 20. Then the security token verification unit 33 inquires into the requested membership information and transmits an inquiry result to the logic processing apparatus 20.

If a verification request for the login maintenance security token is received from the terminal 10, the security token verification unit 33 performs the verification of the login maintenance security token. Namely, the security token verification unit 33 checks whether the login maintenance security token received from a specific terminal is identical with one of login maintenance security tokens issued previously for respective terminals. In case of failure in verification of the login maintenance security token, the security token verification unit 33 transmits a warning message to the logic processing apparatus 20.

Meanwhile, the authentication apparatus 30 configured as discussed above may be implemented as at least one server that operates in a server computing scheme or a cloud computing scheme. Particularly, data for authentication using a security token may be offered through a cloud computing function of a cloud computing apparatus on the internet. Here, cloud computing refers to technique to offer, based on the on-demand technology, internet-based virtualized resources, e.g., hardware (server, storage, network, etc.), software (database, security, web server, etc.), service, data, and the like, to digital terminals such as a desktop computer, a tablet computer, a notebook, a netbook, a smart phone, and the like.

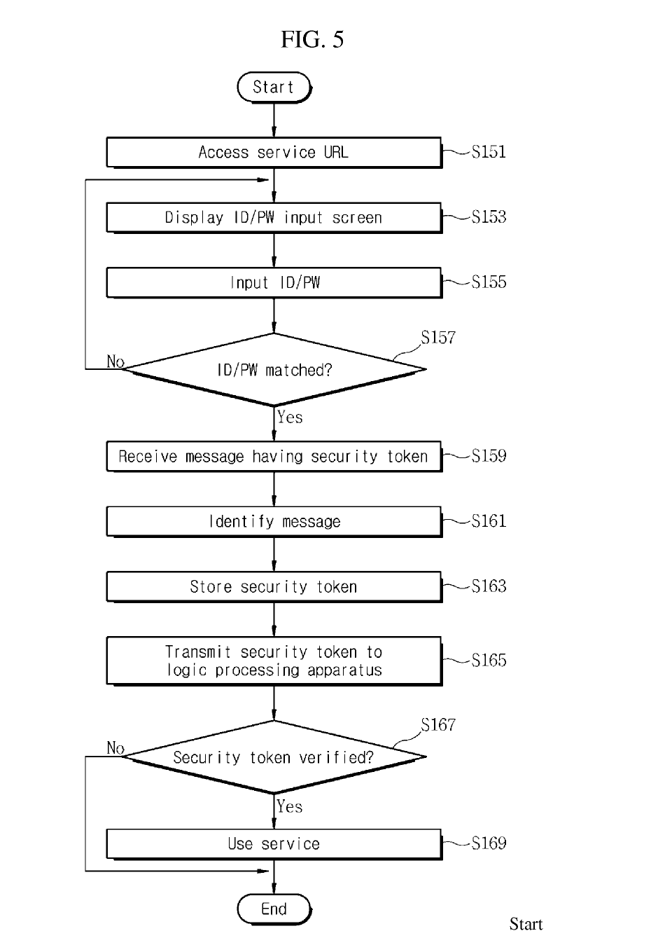

FIG. 4 is a data flow diagram illustrating an authentication process using a security token in accordance with an embodiment of the present invention.

Referring to FIG. 4, in the authentication process using the security token, the terminal 10 accesses at step S101 the logic processing apparatus 20 by using a service URL. When the URL is entered, the authentication apparatus 30 offers at step S103 an image about an ID and password input screen associated with the logic processing apparatus 20. Thereafter, the terminal 10 receives a user input of ID and password through the input screen at step S105 and transmits the user input to the authentication apparatus 30 at step S107.

The authentication apparatus 30 checks at step S109 whether the ID and password received from the terminal 100 are matched with each other, and then determines at step S111 whether authentication succeeds or not. In case of success in login, the authentication apparatus 30 issues the authentication security token at step S113. Here, the authentication security token is a single-use security token which is set to be valid only at the first verification request of the logic processing apparatus 20. Thereafter, at step S115, the authentication apparatus 30 creates a message containing the authentication security token. Namely, this message contains code information of a service providing site, URL information for transmission of the authentication security token, code information for indicating a domestic or foreign site, or information about the authentication security token.

At step S117, the authentication apparatus 30 transmits the created message to the terminal 10. Meanwhile, if the ID and password entered in a login authentication process using ID and password is not matched with each other, the authentication apparatus 30 may perform a re-request for login.

The terminal 10 identifies the message at step S119. At this time, the terminal 10 checks information contained in the message received from the authentication apparatus 30, such as code information of a service providing site, URL information for transmission of the authentication security token, code information for indicating a domestic or foreign site, or information about the authentication security token. Then, at step S121, the terminal 10 stores the identified authentication security token.

At step S123, the terminal 10 transmits the authentication security token to the logic processing apparatus 20. Namely, the terminal 10 knows only address information of the logic processing apparatus 20 at the first access to the logic processing apparatus, and can identify logic IP of the logic processing apparatus 20 by using authentication through the authentication security token offered through the authentication apparatus 30.

If the verification of the authentication security token is requested, the logic processing apparatus 20 requests the authentication apparatus 30 to verify the authentication security token at step S125.

At step S127, the authentication apparatus 30 identifies the authentication security token. At step S129, the authentication apparatus 30 checks whether the authentication security token received from the logic processing apparatus 20 is about the first verification request. In case of the authentication security token about the first verification request, the authentication apparatus 30 creates at step S131 a membership information inquiry key value associated with the terminal 10. On the contrary, if the authentication security token is not about the first verification request, the authentication apparatus 30 may send a warning message to the logic processing apparatus 20 at step A.

At step S133, the authentication apparatus 30 transmits the membership information inquiry key value to the logic processing apparatus 20. Then, at step S135, the logic processing apparatus 20 stores the membership information inquiry key value received from the authentication apparatus 30. Here, the membership information inquiry key value is not limited to a specific form and may be composed of a combination of numbers, letters, and the like in various forms. The membership information inquiry key value may be used in case of requesting inquiry into membership information or any other information such as a user profile.

At step S137, the logic processing apparatus 20 requests the authentication apparatus 30 to inquire into membership information about a user of the terminal 10. At this time, the logic processing apparatus 20 may request such inquiry by using the membership information inquiry key value offered from the authentication apparatus 30.

If there is a request for inquiry into membership information, the authentication apparatus 30 inquires into membership information about a corresponding member at step S139. Here, membership information includes personal information about a user of the terminal 10, information about using the logic processing apparatus, past login information, and the like. Also, at step S141, the authentication apparatus 30 transmits the membership information to the logic processing apparatus 20.

At step S143, the logic processing apparatus 20 identifies the membership information received from the authentication apparatus 30. At this time, the logic processing apparatus 20 may frequently access the authentication apparatus 30 to use membership information.

At step S145, the logic processing apparatus 20 provides a service to the terminal 10. Thereafter, at step S147, the terminal 10 uses the service provided from the logic processing apparatus 20.

As discussed, by performing authentication using a single-use security token, security against outside hacking can be enhanced. Additionally, the use of a single-use security token instead of security or authentication information exposed in an authentication process based on a cookie scheme not only can reduce a token length, data loss, and data usage, but also can improve a data transmission or transfer rate.

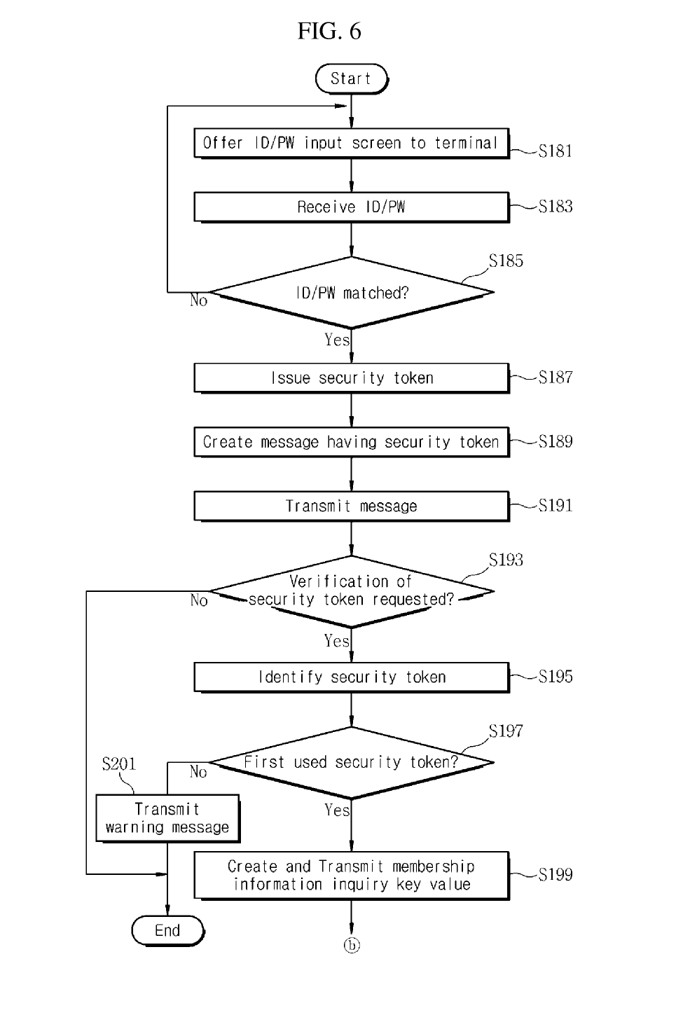

FIG. 5 is a flow diagram illustrating an operating method of a terminal in accordance with an embodiment of the present invention.

Referring to FIG. 5, the terminal 10 according to this invention accesses at step S151 the logic processing apparatus 20 by using a service URL. Then, at step S153, the terminal 10 receives an image about an ID and password input screen associated with the logic processing apparatus 20 from the authentication apparatus 30 according to URL access. Thereafter, at step S155, the terminal 10 receives a user input of ID and password through the input screen and transmits the user input to the authentication apparatus 30.

At step S157, the terminal 10 determines whether login succeeds or not depending on whether the ID and password are matched with each other. In case of success in login, the terminal 10 receives at step S159 a message containing the authentication security token from the authentication apparatus 30. Here, the authentication security token is a single-use security token which is set to be valid only at the first verification request of the logic processing apparatus 20. Also, this message contains code information of a service providing site, URL information for transmission of the authentication security token, code information for indicating a domestic or foreign site, or information about the authentication security token.

Meanwhile, if the ID and password entered in a login authentication process using ID and password is not matched with each other, the terminal 10 outputs an input screen for a re-request for login.

At step S161, the terminal 10 identifies the message received from the authentication apparatus 30. Namely, the terminal 10 checks information contained in the message received from the authentication apparatus 30, such as code information of a service providing site, URL information for transmission of the authentication security token, code information for indicating a domestic or foreign site, or information about the authentication security token. Then, at step S163, the terminal 10 stores the authentication security token.

At step S165, the terminal 10 transmits the authentication security token to the logic processing apparatus 20. Namely, the terminal 10 knows only address information of the logic processing apparatus 20 at the first access to the logic processing apparatus, and can identify logic IP of the logic processing apparatus 20 by using authentication through the authentication security token offered through the authentication apparatus 30.

At step S167, the terminal 10 determines whether the verification of the authentication security token succeeds or not. Namely, if the verification of the authentication security token is about the first verification request, the terminal 10 can use a service through a connection with the logic processing apparatus 20 at step S169.

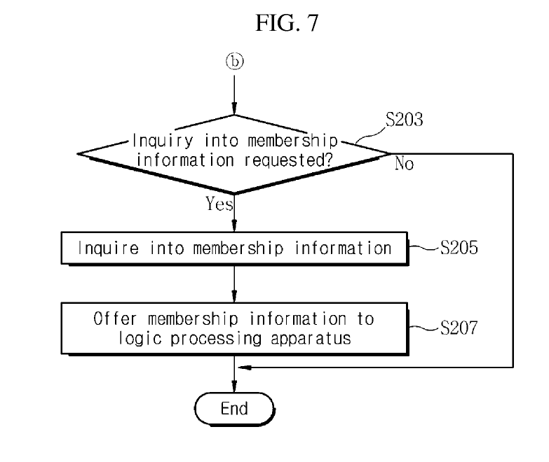

FIGS. 6 and 7 are flow diagrams illustrating an operating method of an authentication apparatus in accordance with an embodiment of the present invention.

Referring to FIGS. 6 and 7, in response to a request for access to a specific site from the terminal 10, the authentication apparatus 30 offers at step S181 an image about an ID and password input screen associated with the logic processing apparatus 20. Thereafter, at step S183, the authentication apparatus 30 receives ID and password from the terminal 10.

At step S185, the authentication apparatus 30 checks whether the ID and password received from the terminal 100 are matched with each other, and then determines whether authentication succeeds or not. In case of success in login, the authentication apparatus 30 issues the authentication security token at step S187. Here, the authentication security token is a single-use security token which is set to be valid only at the first verification request of the logic processing apparatus 20. Thereafter, at step S189, the authentication apparatus 30 creates a message containing the authentication security token. Namely, this message contains code information of a service providing site, URL information for transmission of the authentication security token, code information for indicating a domestic or foreign site, or information about the authentication security token.

At step S191, the authentication apparatus 30 transmits the created message to the terminal 10. Meanwhile, if the ID and password entered in a login authentication process using ID and password is not matched with each other, the authentication apparatus 30 may perform a re-request for login.

At step S193, the authentication apparatus 30 checks whether the verification of the authentication security token is requested from the logic processing apparatus 20. If there is such a request, the authentication apparatus 30 identifies the authentication security token at step S195.

Namely, at step S197, the authentication apparatus 30 determines whether the authentication security token received from the logic processing apparatus 20 is about the first verification request. In case of the authentication security token about the first verification request, the authentication apparatus 30 creates a membership information inquiry key value associated with the terminal 10 and transmits the created membership information inquiry key value to the logic processing apparatus 20 at step S199. Here, the membership information inquiry key value is not limited to a specific form and may be composed of a combination of numbers, letters, and the like in various forms. The membership information inquiry key value may be used in case of requesting inquiry into membership information or any other information such as a user profile. Meanwhile, if the authentication security token is not about the first verification request, the authentication apparatus 30 may send a warning message to the logic processing apparatus 20 at step S201.

At step S203, the authentication apparatus 30 checks whether inquiry into membership information about a user of the terminal 10 is requested from the logic processing apparatus 20. If there is a request for inquiry into membership information, the authentication apparatus 30 inquires into membership information about a corresponding member at step S205. Here, membership information includes personal information about a user of the terminal 10, information about using the logic processing apparatus, past login information, and the like. Also, at step S207, the authentication apparatus 30 transmits the membership information to the logic processing apparatus 20.

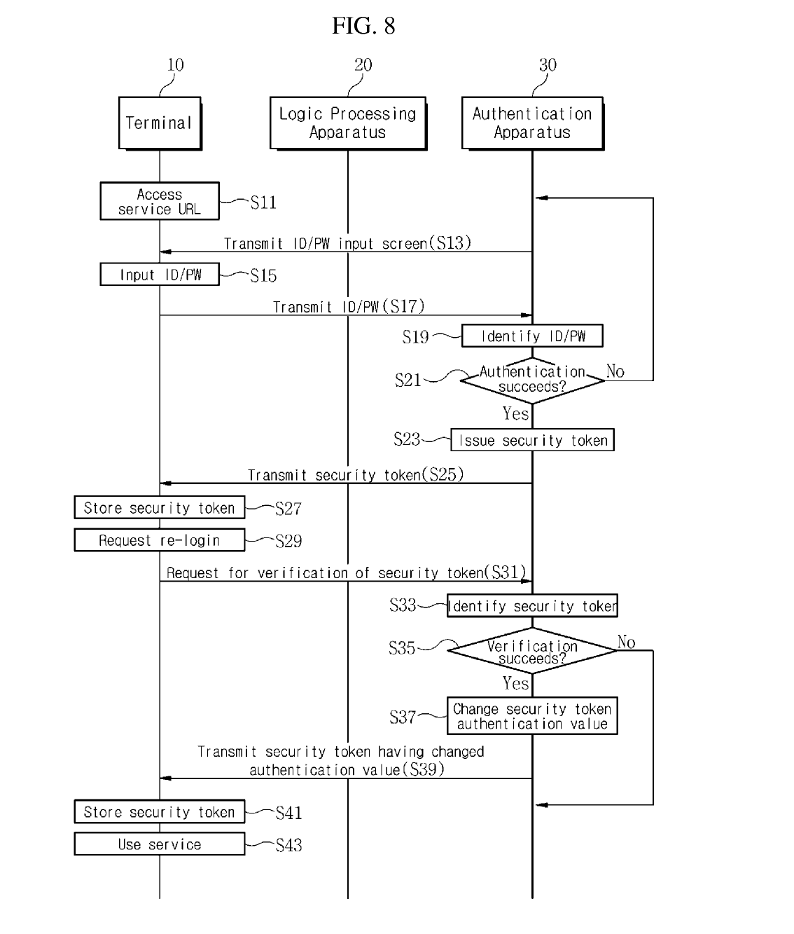

FIG. 8 is a data flow diagram illustrating an authentication process using a security token in case of maintaining login in accordance with another embodiment of the present invention.

Referring to FIG. 8, in the authentication process using the security token, the terminal 10 performs at step S11 access to a service URL for the use of a service. When the URL is entered, the authentication apparatus 30 offers at step S13 an image about an ID and password input screen associated with the logic processing apparatus 20. Thereafter, the terminal 10 receives a user input of ID and password through the input screen at step S15 and transmits the user input to the authentication apparatus 30 at step S17.

The authentication apparatus 30 checks at step S19 whether the ID and password received from the terminal 100 are matched with each other, and then determines at step S21 whether authentication succeeds or not. In case of success in login, the authentication apparatus 30 issues the login maintenance security token at step S23 and then transmits the login maintenance security token to the terminal 10 at step S25. At this time, the login maintenance security token is formed of the first authentication value reissued whenever ID is authenticated, and the second authentication value including information about a user profile for performing login authentication with specific ID.

At step S27, the terminal 10 stores the login maintenance security token received from the authentication apparatus 30.

If there is a request for re-login for using a service, the terminal 10 checks whether there is the login maintenance security token for re-login authentication. If there is the login maintenance security token, the terminal 10 requests at step S31 the authentication apparatus 30 to verify the login maintenance security token.

If the verification of the login maintenance security token for re-login authentication is requested from the terminal 10, the authentication apparatus 30 performs at step S33 the verification of the login maintenance security token. Then, at step S35, the authentication apparatus 30 checks whether the verification succeeds or not. In case of success in verification, the authentication apparatus 30 changes an authentication value of the login maintenance security token at step S37. At this time, by applying various calculation schemes, the authentication apparatus 30 may change the first authentication value from among the first and second authentication values constituting the login maintenance security token. Thereafter, at step S39, the authentication apparatus 30 transmits the login maintenance security token having the changed authentication value to the terminal 10.

Meanwhile, if the verification of the login maintenance security token does not succeed, the authentication apparatus 30 may send a warning message to the logic processing apparatus 20.

At step S41, the terminal 10 stores the security token received again after the verification of the login maintenance security token. Here, the login maintenance security token received from the authentication apparatus 30 has an authentication value changed at the authentication apparatus 30 in response to a request for re-login authentication from the terminal 10. The terminal 10 stores the login maintenance security token having a changed specific authentication value instead of the existing login maintenance security token. Then, at step S43, the terminal 10 uses a service.

As discussed above, by performing authentication through the verification of the security token, to which bidirectional encryption is applied, at the time of re-login for the use of a service, this invention can improve security against outside hacking (cookie hijacking) Additionally, since an authentication value constituting the security token can be changed by applying various calculation schemes, the safety of an authentication procedure is ensured. Further, the use of a single-use security token instead of security or authentication information exposed in an authentication process based on a cookie scheme not only can reduce a token length, data loss, and data usage, but also can improve a data transmission or transfer rate.

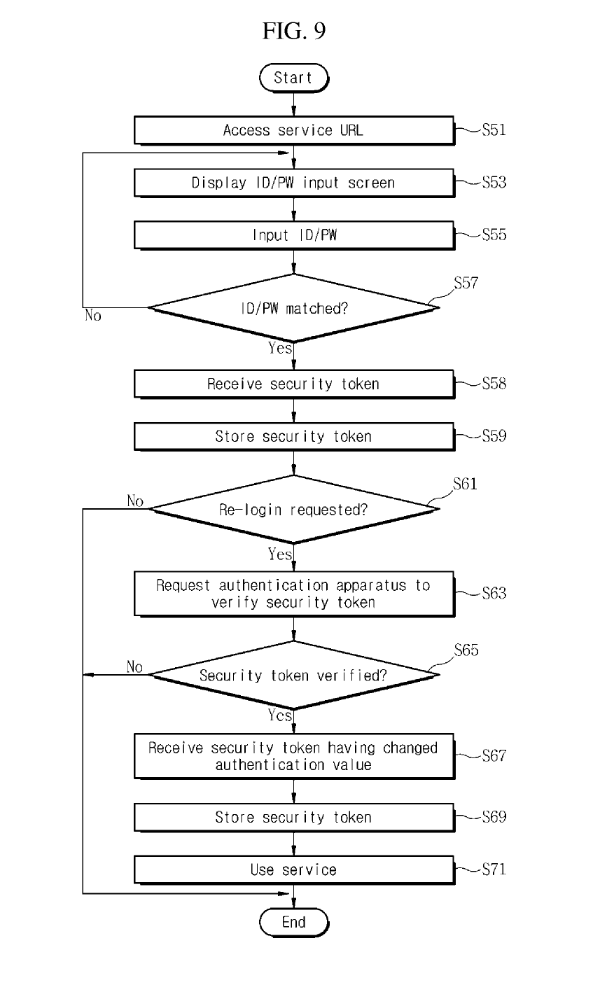

FIG. 9 is a flow diagram illustrating an operating method of a terminal in accordance with another embodiment of the present invention.

Referring to FIG. 9, the terminal 10 according to this invention accesses the logic processing apparatus 20 for providing a service and performs login authentication at steps S51 to S55. Namely, the terminal 10 performs access to a service URL, receives an image about an ID and password input screen from the authentication apparatus 30 according to URL access, and displays the received input screen. Thereafter, the terminal 10 receives a user input of ID and password through the input screen and transmits the user input to the authentication apparatus 30.

At step S57, the terminal 10 determines whether login succeeds or not depending on whether the ID and password are matched with each other. In case of success in login, the terminal 10 receives the login maintenance security token from the authentication apparatus 30 at step S58. Here, the login maintenance security token is formed of the first authentication value (a random value) reissued whenever ID is authenticated, and the second authentication value (a unique value) including information about a user profile for performing login authentication with specific ID. Then, at step S59, the terminal 10 stores the security token received from the authentication apparatus 30.

At step S61, the terminal 10 checks whether re-login for the use of a service is requested. If there is a request for re-login, the terminal 10 requests at step S63 the authentication apparatus 30 to verify the login maintenance security token. Namely, the terminal 10 checks whether there is the security token for re-login authentication. If there is the login maintenance security token, the terminal 10 requests the authentication apparatus 30 to verify the login maintenance security token. Meanwhile, if there is no login maintenance security token, the terminal 10 outputs an input screen for performing login authentication using ID and password.

At step S65, the terminal 10 checks whether the verification of the login maintenance security token succeeds or not. After the verification of the login maintenance security token, the terminal 10 performs re-login authentication based on the login maintenance security token. Namely, at step S67, the terminal 10 receives the login maintenance security token having an authentication value changed according to re-login authentication at the authentication apparatus 30. Thereafter, at step S69, the terminal 10 stores the login maintenance security token having a changed specific authentication value instead of the existing login maintenance security token. Then, at step S71, the terminal 10 uses a service.

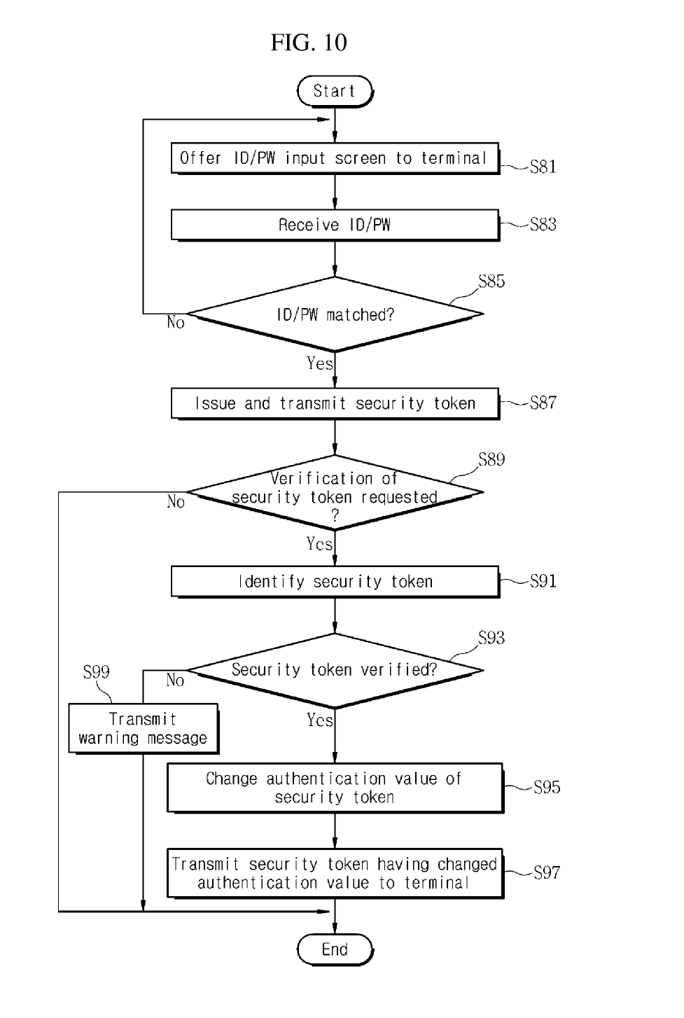

FIG. 10 is a flow diagram illustrating an operating method of an authentication apparatus in accordance with another embodiment of the present invention.

Referring to FIG. 10, in response to a request for access to a service URL from the terminal 10, the authentication apparatus 30 offers at step S81 an image about an ID and password input screen associated with the logic processing apparatus 20. Thereafter, at step S83, the authentication apparatus 30 receives ID and password from the terminal 10.

At step S85, the authentication apparatus 30 determines whether authentication succeeds or not by checking whether the ID and password received from the terminal 100 are matched with each other. In case of success in login, the authentication apparatus 30 issues the login maintenance security token and then transmits the login maintenance security token to the terminal 10 at step S87. At this time, the login maintenance security token is formed of the first authentication value reissued whenever ID is authenticated, and the second authentication value including information about a user profile for performing login authentication with specific ID.

At step S89, the authentication apparatus 30 checks whether the verification of the login maintenance security token is requested from the terminal 10. If the verification of the login maintenance security token is requested for re-login authentication from the terminal 10, the authentication apparatus 30 performs the verification of the login maintenance security token at step S91. Then, at step S93, the authentication apparatus 30 checks whether the verification succeeds or not. In case of success in verification, the authentication apparatus 30 changes an authentication value of the login maintenance security token at step S95. At this time, by applying various calculation schemes, the authentication apparatus 30 may change the first authentication value from among the first and second authentication values constituting the login maintenance security token. For example, the security token may be formed of “0101abc” having the second authentication value “0101” and the first authentication value “abc”. In this case, the first authentication value may be changed every re-login to the logic processing apparatus 20. Namely, the login maintenance security token may be used as “0101abc” at the first login, used as “0101efg” at the second login, and used as “0101hij” at the third login. Here, the authentication apparatus 30 may change the first authentication value from among the first and second authentication values constituting the login maintenance security token by applying various calculation schemes such as +, −, shift, or the like.

Thereafter, at step S97, the authentication apparatus 30 transmits the login maintenance security token having the changed authentication value to the terminal 10.

Meanwhile, if the verification of the login maintenance security token does not succeed, the authentication apparatus 30 may send a warning message to the terminal 10 at step S99.

Meanwhile, the memory installed in the terminal 10 or in the authentication apparatus 30 stores information therein. In an embodiment, the memory is a computer-readable medium. The memory may be a volatile memory unit in an embodiment or a nonvolatile memory unit in another embodiment. In an embodiment, the storage is a computer-readable medium. In various embodiments, the storage may include, for example, a hard disk device, an optical disk device, or any other mass storage device.

Although an exemplary configuration of the apparatus is disclosed in the description and drawings, the above-discussed embodiments of functional operations and subject matters may be implemented in any other type of digital electronic circuitry, or in any computer software, firmware or hardware including the structures disclosed herein and their structural equivalents, or in any combination thereof. Embodiments of the above-discussed subject matter may be implemented as one or more computer program products, i.e., one or more modules of computer program instructions encoded on a program storage medium for execution by, or to control the operation of, the apparatus according to this invention. A computer-readable medium may be a machine-readable storage device, a machine-readable storage substrate, a memory device, a machine-readable composition of material affecting a radio wave type signal, or any combination thereof.

Computer-readable recording media suitable for storing computer program instructions and data include, for example, magnetic media such as a hard disk, a floppy disk and a magnetic tape, optical media such as CD-ROM (Compact Disk Read Only Memory) and DVD (Digital Video Disk), magneto-optical media such as floptical disk, and a semiconductor memory such as ROM (Read Only Memory), RAM (Random Access Memory), flash memory, EPROM (Erasable Programmable ROM), and EEPROM (Electrically Erasable Programmable ROM). A processor and memory may be supplemented with a special purpose logic circuit or integrated thereto. Program instructions may include machine language codes made by a complier and high-level language codes executable in a computer using an interpreter or the like. These hardware devices may be configured to operate as one or more software modules to perform the operation of this invention, and vice versa.

Various modifications to the implementations described in this disclosure may be readily apparent to those skilled in the art, and the generic principles defined herein may be applied to other implementations without departing from the spirit or scope of this disclosure. Thus, the disclosure is not intended to be limited to the implementations shown herein, but is to be accorded the widest scope consistent with the claims, the principles and the novel features disclosed herein. Certain features that are described in this specification in the context of separate implementations also can be implemented in combination in a single implementation. Conversely, various features that are described in the context of a single implementation also can be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

While this invention has been particularly shown and described with reference to an exemplary embodiment thereof, it will be understood by those skilled in the art that various changes in form and details may be made therein without departing from the spirit and scope of this invention as defined by the appended claims.

The present invention can enhance security against outside hacking by performing verification using a single-use security token at the time of access to the logic processing apparatus and by performing authentication through the verification of the security token, to which bidirectional encryption is applied, at the time of re-login for the use of a service on a web. Additionally, since the authentication value constituting the security token can be changed by applying various calculation schemes, the safety of an authentication procedure is ensured. Furthermore, the use of a single-use security token instead of security or authentication information exposed in an authentication process based on a cookie scheme not only can reduce a token length, data loss, and data usage, but also can improve a data transmission or transfer rate. This has a good possibility of sales on the market or business and also has industrial applicability suitable for practical and apparent implementation.

What is claimed is:

1. An authentication apparatus comprising:
a service communication unit connected with at least one terminal and a logic processing apparatus and configured to transmit or receive data for performing authentication using an authentication security token and data for maintaining login using a login maintenance security token;
an integrated ID management unit configured to perform login authentication in response to a request of the terminal;
a security token creation unit configured to issue the authentication security token in case of success in login, and to transmit a message containing the authentication security token to the terminal; and
a security token verification unit configured to perform verification of the authentication security token when the verification of the authentication security token is requested from the logic processing apparatus, and to offer membership information to the logic processing apparatus by applying a membership information inquiry key value when the authentication security token is verified.

2. The authentication apparatus of claim 1, wherein the authentication security token is a single-use security token which is issued through the security token creation unit and is set to be valid only at a first verification request of the logic processing apparatus.

3. The authentication apparatus of claim 1, wherein the login maintenance security token is formed of a first authentication value reissued whenever ID is authenticated, and a second authentication value including information about a user profile for performing login authentication with specific ID.

4. The authentication apparatus of claim 1, wherein the security token verification unit is further configured to check whether the authentication security token received from the logic processing apparatus is about a first verification request, and in case of the authentication security token about the first verification request, to create and offer a membership information inquiry key value associated with the terminal to the logic processing apparatus.

5. The authentication apparatus of claim 1, wherein the security token creation unit is further configured to issue and transmit the login maintenance security token to the terminal when the login succeeds, and to change and transmit an authentication value of the login maintenance security token to the terminal in response to a request for re-login authentication.

6. The authentication apparatus of claim 1, wherein the security token verification unit is further configured to perform verification of the login maintenance security token when the verification of the login maintenance security token for re-login authentication of the logic processing apparatus is requested from the terminal.

7. A terminal comprising:
a communication unit configured to communicate with an authentication apparatus and a logic processing apparatus for providing a service, and to transmit or receive data for performing authentication using an authentication security token and data for performing login maintenance using a login maintenance security token; and
a control unit configured to perform login authentication by accessing the logic processing apparatus, to receive a message containing the authentication security token from the authentication apparatus in case of success in login, to transmit the authentication security token identified by analyzing the received message to the logic processing apparatus, and to control use of a plurality of services provided from the logic processing apparatus depending on a verification result of the authentication security token.

8. The terminal of claim 7, further comprising:
a memory unit configured to store the authentication security token identified by analyzing the message received from the authentication apparatus, and the login maintenance security token received for re-login from the authentication apparatus or identified by analyzing the message received from the authentication apparatus.

9. The terminal of claim 7, wherein the control unit is further configured to check whether there is the login maintenance security token for re-login authentication, to request the authentication apparatus to verify the login maintenance security token if there is the login maintenance security token, to perform re-login authentication based on the login maintenance security token when the login maintenance security token is verified, and to receive the login maintenance security token having an authentication value changed according to re-login authentication from the authentication apparatus.

10. An authentication method using a security token, comprising steps of:
at a terminal, performing login authentication by accessing a specific logic processing apparatus;
at the terminal, receiving a message containing an authentication security token from an authentication apparatus in case of success in login;
at the terminal, identifying the authentication security token by analyzing the received message;
at the terminal, transmitting the authentication security token to the logic processing apparatus; and
at the terminal, using a plurality of services provided from the logic processing apparatus depending on a verification result of the authentication security token.

11. The authentication method of claim 10, wherein the identifying step includes, at the terminal, checking information contained in the message received from the authentication apparatus, the information corresponding to one or more of code information of a service providing site, URL information for transmission of the authentication security token, code information for indicating a domestic or foreign site, and information about the authentication security token.

12. The authentication method of claim 10, further comprising step of:
at the terminal, storing the authentication security token contained in the message after the identifying step.

13. An authentication method using a security token, comprising steps of:
at an authentication apparatus, performing login authentication for access to a specific logic processing apparatus in response to a request of at least one terminal;
at the authentication apparatus, issuing an authentication security token in case of success in login;
at the authentication apparatus, transmitting a message containing the authentication security token to the terminal;
at the authentication apparatus, performing verification of the authentication security token when the verification of the authentication security token is requested from the logic processing apparatus; and
at the authentication apparatus, offering membership information to the logic processing apparatus by applying a membership information inquiry key value when the authentication security token is verified.

14. The authentication method of claim 13, wherein the step of performing the login authentication includes steps of:
at the authentication apparatus, offering an input screen for ID and password in response to a request for access to the logic processing apparatus; and
at the authentication apparatus, receiving ID and password from the terminal and identifying the received ID and password.

15. The authentication method of claim 13, wherein the step of performing the verification of the authentication security token includes steps of:
at the authentication apparatus, checking whether the authentication security token received from the logic processing apparatus is about a first verification request; and
at the authentication apparatus, in case of the authentication security token about the first verification request, creating a membership information inquiry key value associated with the terminal.

16. The authentication method of claim 13, wherein the step of performing the verification of the authentication security token includes step of:
at the authentication apparatus, if the authentication security token is not about a first verification request, sending a warning message to the logic processing apparatus.

17. The authentication method of claim 13, wherein the offering step includes steps of:
at the authentication apparatus, receiving an inquiry request for membership information associated with the membership inquiry key value from the logic processing apparatus;
at the authentication apparatus, inquiring into the membership information in response to the request; and
at the authentication apparatus, transmitting an inquiry result to the logic processing apparatus.

18. An authentication method using a security token, comprising steps of:
at a terminal, checking whether there is a login maintenance security token for re-login authentication;
at the terminal, requesting an authentication apparatus to verify the login maintenance security token if there is the login maintenance security token;
at the terminal, performing re-login authentication based on the login maintenance security token when the login maintenance security token is verified; and
at the terminal, receiving the login maintenance security token having an authentication value changed according to the re-login authentication from the authentication apparatus.

19. The authentication method of claim 18, further comprising steps of:
at the terminal, before the checking step, performing login authentication for providing a service;
at the terminal, receiving a login maintenance security token from the authentication apparatus in case of success in login; and
at the terminal, storing the received login maintenance security token.

20. The authentication method of claim 18, wherein the checking step includes step of:
at the terminal, outputting an input screen for performing login authentication by using ID and password if there is no login maintenance security token.

21. The authentication method of claim 18, further comprising step of:
at the terminal, after the receiving step, storing the login maintenance security token having a changed specific authentication value instead of an existing login maintenance security token.

22. An authentication method using a security token, comprising steps of:
at an authentication apparatus, performing login authentication for access to a logic processing apparatus for providing a service in response to a request of at least one terminal;
at the authentication apparatus, issuing a login maintenance security token in case of success in login;
at the authentication apparatus, performing verification of the login maintenance security token when the verification of the login maintenance security token for re-login authentication is requested from the terminal;
at the authentication apparatus, changing an authentication value of the login maintenance security token when the login maintenance security token is verified; and
at the authentication apparatus, transmitting the login maintenance security token having the changed authentication value to the terminal.

23. The authentication method of claim 22, wherein the step of performing the login authentication includes steps of:
at the authentication apparatus, offering an input screen for ID and password; and
at the authentication apparatus, receiving ID and password from the terminal and identifying the received ID and password.

24. The authentication method of claim 22, wherein the step of performing the verification of the login maintenance security token includes, at the authentication apparatus, checking whether the login maintenance security token received from a specific terminal is identical with one of login maintenance security tokens issued previously for respective terminals.

25. The authentication method of claim 22, further comprising step of:
at the authentication apparatus, after the step of performing the verification of the login maintenance security token includes, transmitting a warning message to the terminal in case of failure in verification of the login maintenance security token.

26. The authentication method of claim 22, wherein the changing step includes, at the authentication apparatus, changing a first authentication value, from among first and second authentication values constituting the login maintenance security token, by applying at least one calculation scheme.
